(19) United States
(12) Patent Application Publication
(10) Pub. No.: US 2025/0251563 A1
(43) Pub. Date: Aug. 7, 2025

(54) LENS UNIT AND IMAGING APPARATUS

(71) Applicant: CANON KABUSHIKI KAISHA, Tokyo (JP)

(72) Inventors: SHU ITO, Tochigi (JP); YOSHIKAZU SATO, Tokyo (JP); KAZUHIKO ABE, Kanagawa (JP); TOMOYUKI SAITO, Chiba (JP)

(21) Appl. No.: 19/038,529

(22) Filed: Jan. 27, 2025

(30) Foreign Application Priority Data
Feb. 2, 2024 (JP) 2024-014862

(51) Int. Cl. G02B 7/02

(52) U.S. Cl. CPC G02B 7/02

(57) ABSTRACT

A lens unit in which tilt variation of a lens holding frame caused by change in environmental temperature is simply restrained with a compact constitution and which has an optical member including a lens, a resin-molded holding frame holding the optical member, a guide member guiding movement of the holding frame in a direction along an optical axis of the optical member, a holding portion holding the optical member, a guided portion abutting the guide member, and a first connection portion connecting the holding portion and the guided portion. The first connection portion has a first shape in which a first thickness and a second thickness smaller than the first thickness are alternately repeated a plurality of times in a direction along the optical axis from a position overlapping the holding portion when viewed in a direction orthogonal to the optical axis.

### BACKGROUND

### Technical Field

The present disclosure relates to a lens unit and an imaging apparatus.

### Description of the Related Art

Some optical instruments, such as digital cameras, video cameras, and interchangeable lenses, have a holding member holding a lens and a guide member guiding movement of this holding member. When the environmental temperature changes during use, the tilt of the holding member changes, resulting in a problem of deterioration in optical performance.

Japanese Patent No. 6887064 discloses a technology in which a guided portion is provided with a tilt prevention member having a smaller coefficient of linear expansion than a lens holding member in order to prevent change in tilt with respect to an optical axis direction of the lens holding member caused by a difference in amounts of thermal expansion and thermal contraction depending on the position of the guided portion due to change in environmental temperature.

### SUMMARY

A lens unit according to an aspect of embodiments of the present disclosure has an optical member including a lens, a resin-molded holding frame holding the optical member, a guide member guiding movement of the holding frame in a direction along an optical axis of the optical member, a holding portion holding the optical member, a guided portion abutting the guide member, and a first connection portion connecting the holding portion and the guided portion. The first connection portion has a first shape in which a first thickness and a second thickness smaller than the first thickness are alternately repeated a plurality of times in a direction along the optical axis from a position overlapping the holding portion when viewed in a direction orthogonal to the optical axis.

Further features of the present disclosure will become apparent from the following description of exemplary embodiments with reference to the attached drawings.

### BRIEF DESCRIPTION OF THE DRAWINGS

FIG. 1 is a cross-sectional view of an interchangeable lens according to First embodiment.

FIG. 2 is a perspective view of a lens unit according to First embodiment.

FIGS. 3A and 3B are views showing a difference in contraction depending on fiber orientations.

FIG. 4 is a view showing deformation in a guided portion of a holding frame caused by change in environmental temperature.

FIGS. 5A and 5B are perspective views of the holding frame according to First embodiment.

FIGS. 6A and 6B are a front view and a cross-sectional view of the holding frame according to First embodiment.

FIG. 7 is a view showing fiber orientations of the holding frame according to First embodiment.

FIG. 8 is another view showing fiber orientations of the holding frame according to First embodiment.

FIG. 9 is a graph showing an effect of restraining change in tilt in the lens unit according to First embodiment.

FIGS. 10A to 10C are cross-sectional views of the holding frame according to another embodiment.

FIG. 11 is a front view of the holding frame according to First embodiment.

FIG. 12 is a perspective view of the holding frame according to another embodiment.

FIGS. 13A and 13B are a perspective view and a front view of the holding frame according to another embodiment.

FIGS. 14A and 14B are cross-sectional views of the holding frame according to another embodiment.

### DESCRIPTION OF THE EMBODIMENTS

Hereinafter, with reference to the accompanying drawings, preferred embodiments of the present disclosure will be described using examples and diagrams. In each diagram, the same reference numbers are applied to the same members and elements, and duplicate description will be omitted or simplified. In addition, the X-X axis in the diagrams represents an optical axis (which will hereinafter be regarded as an optical axis X).

### First Embodiment

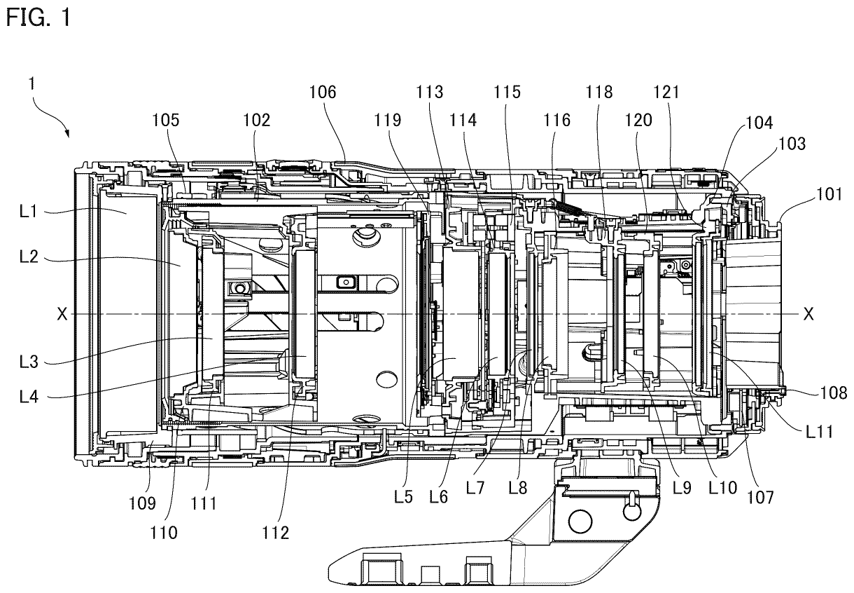

Hereinafter, a lens unit according to a Present Embodiment will be described. FIG. 1 is an example of a cross-sectional view of a lens device (interchangeable lens) 1 that functions as an optical device according to the Present Embodiment. Here, the lens device 1 will be described using a zoom lens, but it is not limited to a zoom lens.

In FIG. 1, a mount 101 is a component fixed to a camera main body (not shown) in which an image sensor imaging a subject through an optical member (lens), and the like are disposed. That is, the mount 101 in the lens device 1 is constituted to be able to be mounted on the mount of the camera main body and can be connected to the camera main body so as to be able to communicate with it by being mounted on the mount of the camera main body. Moreover, an imaging apparatus can be constituted of the lens device 1 and the camera main body having the image sensor. The imaging apparatus has a constitution capable of capturing images formed through the lens device 1. The imaging apparatus may be an imaging apparatus in which the lens device 1 and a camera main body are integrated.

A guide barrel 102 is integrally fixed to the mount 101 together with a fixed barrel 103 via a rear group base 104. A cam ring 105 is held on the outer circumference of the guide barrel 102 so as to be rotatable around the optical axis X. The cam ring 105 is coupled to a zoom ring 106 rotatably held on the outer circumference of the fixed barrel 103 by a key member (not shown) and is constituted to integrally rotate when the zoom ring 106 is operated from the outside.

A zoom sensor (not shown) is attached to the fixed barrel 103. The zoom sensor is a sensor capable of electrically detecting the rotation angle of the zoom ring 106, is electrically connected to a control board 107 disposed in the vicinity of the mount 101, and transmits focal length information at the time of zooming to a control circuit. A contact block 108 is electrically connected to the control board (control unit) 107 that includes a CPU, a memory, and the like and is constituted as at least one computer having functions of communicating with the camera main body (not shown) and receiving power supply.

A first group lens L1 is held by a first group lens barrel 109. The first group lens barrel 109 is fixed to the guide barrel 102. A second group lens L2 is held by a second group lens barrel 110. A third group lens L3 is held by a third group lens barrel 111. A fourth group lens L4 is held by a fourth group lens barrel 112. A fifth group lens L5 is held by a fifth group lens barrel 113. The fifth group lens barrel 113 is fixed to the rear group base 104. An electromagnetic aperture unit 119 is held by the fifth group lens barrel 113, which is electrically connected to the control board 107.

A sixth group lens L6 is held by a sixth group lens barrel 114. The sixth group lens barrel 114 is movably held by a shift unit 115 within a plane orthogonal to the optical axis. The shift unit 115 includes an actuator for driving the sixth group lens barrel 114, a sensor for detecting the driving amount, and the like and is fixed to the rear group base 104. The shift unit 115 is electrically connected to the control board 107. The control board 107 drives and controls the sixth group lens barrel 114 so as to correct shaking based on a shake signal, which is detected by an acceleration sensor (not shown) attached to the fixed barrel 103.

A seventh group lens L7 is held by the rear group base 104. An eighth group lens L8 is held by an eighth group lens barrel 116 and is held by a guide bar 117 (which will be described below) so as to be movable in the optical axis X direction (direction along the optical axis X). The eighth group lens L8 is a focus adjusting lens and is driven in the optical axis X direction by a linear ultrasonic motor (not shown) held by the rear group base 104. The linear ultrasonic motor ultrasonically vibrates a piezoelectric element and drives it in the optical axis X direction. Since the linear ultrasonic motor is based on a known technology, detailed description will be omitted. The linear ultrasonic motor is electrically connected to the control board 107 by a flexible board (not shown).

A ninth group lens L9 is held by a ninth group lens barrel 118. The ninth group lens barrel 118 is fixed to the rear group base 104. A tenth group lens L10 is held by a tenth group lens barrel 120 and is held by a guide bar (not shown) so as to be movable in the optical axis X direction. Similar to the eighth group lens L8, the tenth group lens L10 is a focus adjusting lens and is driven in the optical axis X direction by a linear ultrasonic motor (not shown) held by the rear group base 104. The linear ultrasonic motor is electrically connected to the control board 107 by a flexible board (not shown). Here, description will be given using linear ultrasonic motors as driving mechanisms for the focus adjusting lenses (the eighth group lens L8 and the tenth group lens L10), but other motors may be used. An eleventh group lens L11 is held by an eleventh group lens barrel 121. The eleventh group lens barrel 121 is fixed to the rear group base 104. The first group lens L1 to the eleventh group lens L11 also serve as optical members.

Each of the second group lens L2, the third group lens L3, and the fourth group lens L4 is a lens moving during zooming, and a cam follower (not shown) is fixed to the second group lens barrel 110, the third group lens barrel 111, and the fourth group lens barrel 112. Each cam follower engages with a straight groove provided in the guide barrel 102 and a cam groove provided in the cam ring 105 and is individually constituted to be able to move straight in the optical axis X direction when the cam ring 105 is rotated.

In addition, the eighth group lens L8 and the tenth group lens L10 for focus adjustment are driven in the optical axis X direction by the linear ultrasonic motors in accordance with zooming. During zooming, at each focal length from a wide-angle side to a telephoto side, positional information (focal position information) of the eighth group lens L8 and the tenth group lens L10 focusing on respective focal positions from infinity to close range is stored as data in a storage medium (a memory or the like) or the like inside the control board 107. Further, the eighth group lens L8 and the tenth group lens L10 are driven and controlled by the control board 107 based on the stored positional information and the focal length information detected by the zoom sensor (not shown).

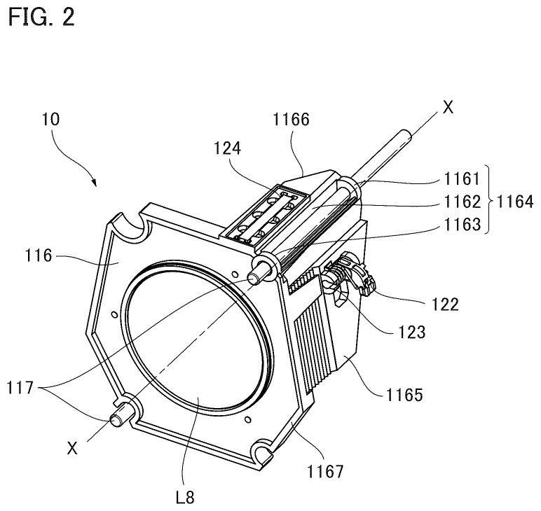

Next, a holding structure of the eighth group lens barrel 116 according to the Present Embodiment will be described. FIG. 2 is a perspective view showing an eighth group lens barrel unit 10.

The eighth group lens barrel unit (lens unit) 10 is constituted of the eighth group lens L8, the eighth group lens barrel 116, a rack 122, a rack spring 123, and a scale 124. The eighth group lens barrel unit 10 is guided straight by the guide bar 117 sandwiched between the rear group base 104 and a guide bar cover (not shown). In other words, the guide bar 117 also functions as a guide member guiding movement of the eighth group lens barrel 116, which also serves as a lens holding frame, in the optical axis X direction.

The rack 122 is biased in a direction orthogonal to the optical axis X (radial direction) in a manner of being fitted to a linear ultrasonic motor (not shown) due to a biasing force of the rack spring 123. In addition, the rack 122 is biased in the optical axis X direction with respect to the eighth group lens barrel 116 by the rack spring 123. The eighth group lens barrel 116 is biased with respect to the guide bar 117 by a biasing force of the rack spring 123 in a direction orthogonal to the optical axis.

The scale 124 is fixed to the eighth group lens barrel 116. An optical sensor for detecting an eighth group position (not shown) facing the scale 124 is fixed to the rear group base 104 with a flexible printed board therebetween. The relative position of the eighth group lens barrel unit 10 with respect to the rear group base 104 is detected by the scale 124 and the optical sensor for detecting the eighth group position.

The eighth group lens barrel 116 has a guided portion 1164, a first connection portion 1165, a third connection portion 1166, and a holding portion 1167.

The guided portion 1164 is constituted of a first abutment portion 1161 and a second abutment portion 1163 abutting the guide bar 117, and a second connection portion 1162 connecting the first abutment portion 1161 and the second abutment portion 1163. The first abutment portion 1161 and the second abutment portion 1163 are provided in the guided portion 1164 so as to be separated in the optical axis X direction.

The holding portion 1167 has a shape holding the eighth group lens L8. The first connection portion 1165 connects the holding portion 1167 and the guided portion 1164. The third connection portion 1166 connects the holding portion 1167 and the guided portion 1164.

In Present Embodiment, the eighth group lens barrel 116 is resin-molded. Specifically, it is molded using fiber-reinforced plastic. Fiber-reinforced plastic is reinforced plastic whose strength has been improved by combination with fibers such as glass fibers or carbon fibers. In fiber-reinforced plastic, the glass fibers or the carbon fibers described above exhibit directions (which will hereinafter be described as fiber orientations) at the time of molding.

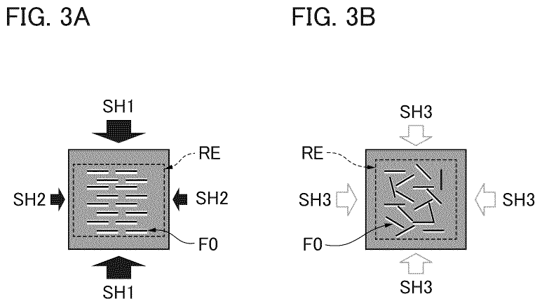

FIG. 3 is a view showing a difference in expansion and contraction due to a difference in directions of fibers F0 when the environmental temperature of a resin RE changes. FIG. 3A is a view showing an example of a state in which the fiber orientations are aligned in one direction. FIG. 3B is a view showing an example of a state in which the fiber orientations are random.

In FIG. 3A, expansion and contraction of the resin RE in a direction orthogonal to the directions of the fibers F0 are indicated by the arrows SH1. In addition, expansion and contraction of the resin RE in a direction parallel to the directions of the fibers F0 are indicated by the arrows SH2. The expansion and contraction of the resin RE in a direction perpendicular to the fibers indicated by the arrows SH1 are greater than the expansion and contraction of the resin RE in a direction parallel to the fibers indicated by the arrows SH2.

In FIG. 3B, expansion and contraction of the resin RE in vertical directions and transverse directions are indicated by the arrows SH3. If the fibers F0 are randomly disposed, the amounts of expansion and contraction become substantially equivalent to each other as indicated by the arrows SH3 regardless of the directions, such as the vertical directions and the transverse directions. The state of FIG. 3A shows a state in which the fiber orientations are aligned.

In FIG. 3A, although there is a difference in degrees of expansion and contraction of the fibers F0 between the parallel directions and the perpendicular directions, the shape merely expands and contracts in one direction ultimately and no deformation such as bending of the resin RE occurs. Next, in FIG. 3B, since the fiber orientations are random, the amounts of expansion and contraction in the vertical directions and the transverse directions become the same so that the resin RE merely expands and contracts uniformly and no deformation such as bending occurs. On the other hand, when the directions of some of the fibers F0 not corresponding to those in FIGS. 3A and 3B are in a state of not being aligned with the directions of the surrounding fibers F0, deformation of the resin RE, such as bending, will occur during expansion and contraction. When such a state of the fiber orientations occurs in the lens holding frame, this will lead to occurrence of a tilt when the environmental temperature changes.

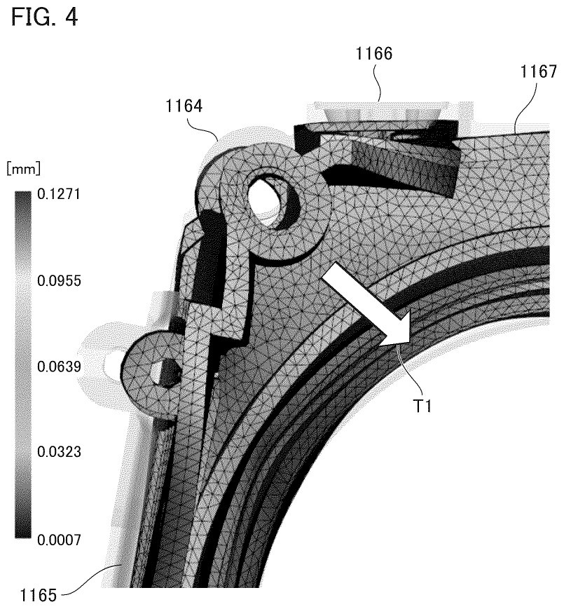

FIG. 4 is a view showing a simulation result of deformation around the guided portion 1164 when the environmental temperature of the eighth group lens barrel 116 has changed from room temperature to approximately −20° C. As shown in FIG. 4, the guided portion 1164 has tilted in the direction indicated by the arrow T1.

Due to occurrence of change in tilt as indicated by the arrow T1, the eighth group lens L8 tilts with respect to the optical axis X direction, and deterioration occurs in optical performance of the lens device 1. This change in tilt is caused when the fiber orientations around the guided portion 1164 are misaligned. In addition, the amount of change in tilt is determined depending on the mechanical strength of the surrounding portions of the guided portion 1164. Therefore, in order to restrain change in tilt caused by change in environmental temperature, there is a need to achieve two points, such as alignment of the fiber orientations around the guided portion 1164 and enhancement of the mechanical strength around the guided portion 1164.

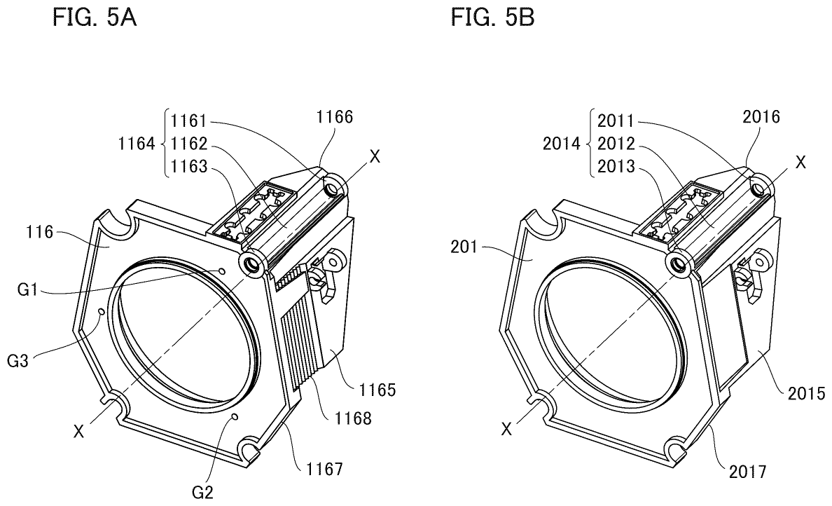

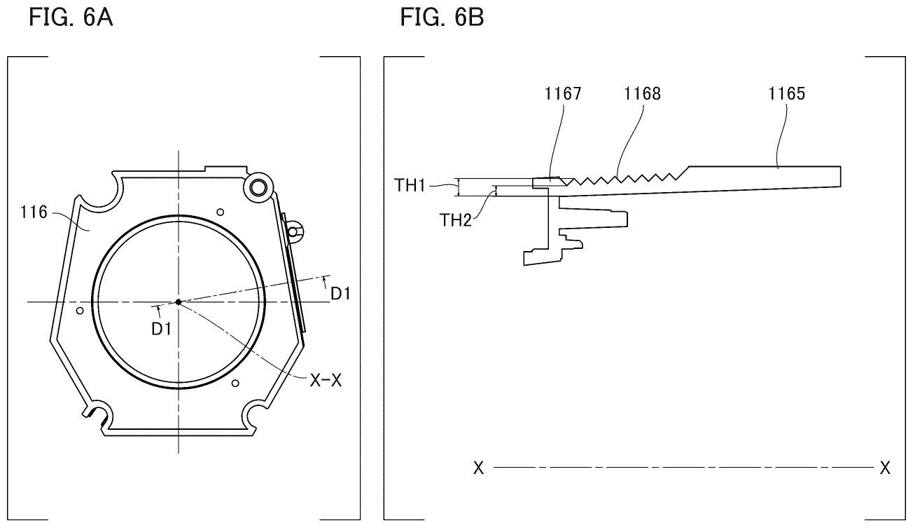

FIG. 5 is a view showing examples of perspective views of the holding frame (eighth group lens barrel 116) according to Present Embodiment. FIG. 5A is a perspective view of the eighth group lens barrel 116 which also serves as a lens holding frame having the constitution of Present Embodiment. FIG. 5B is a perspective view of an eighth group lens barrel 201 which also serves as a lens holding frame not having the constitution of Present Embodiment. FIG. 6 shows a front view and a cross-sectional view of the holding frame (eighth group lens barrel 116) according to Present Embodiment. FIG. 6A is a front view of the eighth group lens barrel 116. FIG. 6B is a cross-sectional view of the cross section D1-D1 in FIG. 6A.

As shown in FIGS. 5A, 6A, and 6B, the eighth group lens barrel 116 has an uneven shape (first shape) 1168 in which a thickness TH1 (first thickness) and a thickness TH2 (second thickness) thinner (smaller) than the thickness TH1 are alternately repeated a plurality of times in the optical axis X direction. In this manner, the uneven shape 1168 is a shape in which large and small thicknesses are alternately repeated a plurality of times. Since the thickness TH1 is thicker (larger) than the thickness TH2, it protrudes outward in a direction orthogonal to the optical axis X from the thickness TH2.

The uneven shape 1168 is provided in the first connection portion 1165 connecting the guided portion 1164 and the holding portion 1167. That is, the first connection portion 1165 has the first shape (uneven shape 1168) in which the first thickness (thickness TH1) and the second thickness (thickness TH2) smaller than the first thickness are alternately repeated a plurality of times in the optical axis X direction from a position overlapping the holding portion 1167 when viewed in a direction orthogonal to the optical axis X. In addition, the uneven shape 1168 is provided in the first connection portion 1165 so as to be positioned (disposed) on the outward side from the optical axis X direction in a direction orthogonal to the optical axis X.

The uneven shape 1168 is a shape in which large and small thicknesses are alternately repeated as described above. That is, the uneven shape 1168 has a plurality of mountain portions having the thickness TH1 and a plurality of valley portions having the thickness TH2 and is formed in the first connection portion 1165 as a shape in which large and small thicknesses are alternately repeated in the optical axis X direction by alternately connecting the mountain portions and the valley portions in a continuous manner. For example, the uneven shape 1168 may be provided in the first connection portion 1165 as at least any of a shape in which recesses and projections are continuously formed and a teeth shape (zigzag shape).

The uneven shape 1168 may be a shape having only one recess. However, it is more preferable to be a shape in which large and small thicknesses are alternately repeated in the optical axis X direction in terms of strength and in terms of restraining the amount of change in tilt caused by change in environmental temperature, which will be described below.

It is favorable that the pitch (interval) between the first thicknesses (thicknesses TH1) and the second thicknesses (thicknesses TH2) in the uneven shape 1168 be narrow. In addition, it is preferable to form as many recesses and projections, that is, first thicknesses (thicknesses TH1) and second thicknesses (thicknesses TH2) as possible within a range they can be formed in a first connection portion.

In addition, it is preferable that the uneven shape 1168 be provided at a position overlapping the holding portion 1167 when viewed in a direction orthogonal to the optical axis X. In the eighth group lens barrel 116, gates at the time of molding are disposed at positions of a gate G1, a gate G2, and a gate G3. The gate G1, the gate G2, and the gate G3 according to Present Embodiment function as inlets when pouring a resin for molding the eighth group lens barrel 116.

The eighth group lens barrel 201 shown in FIG. 5B has a guided portion 2014, a first connection portion 2015, a third connection portion 2016, and a holding portion 2017.

The guided portion 2014 is constituted of a first abutment portion 2011 and a second abutment portion 2013 abutting the guide bar 117, and a second connection portion 2012 connecting the first abutment portion 2011 and the second abutment portion 2013. The holding portion 2017 has a shape holding the eighth group lens L8. The first connection portion 2015 connects the holding portion 2017 and the guided portion 2014. The third connection portion 2016 connects the holding portion 2017 and the guided portion 2014. The eighth group lens barrel 201 shown in FIG. 5B does not have a shape as the uneven shape 1168 of the eighth group lens barrel 116 according to Present Embodiment.

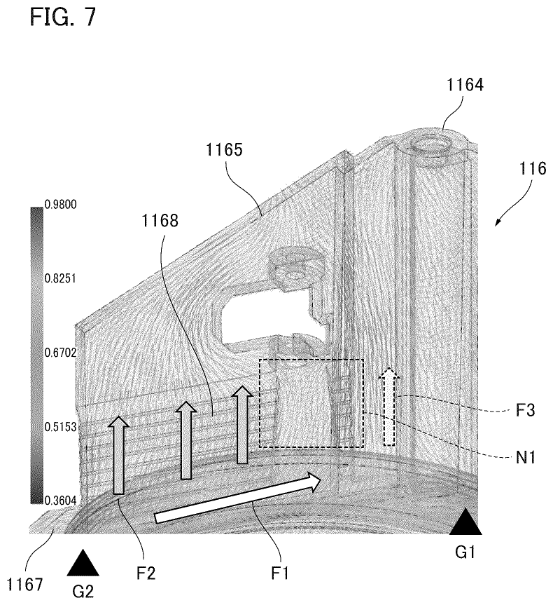

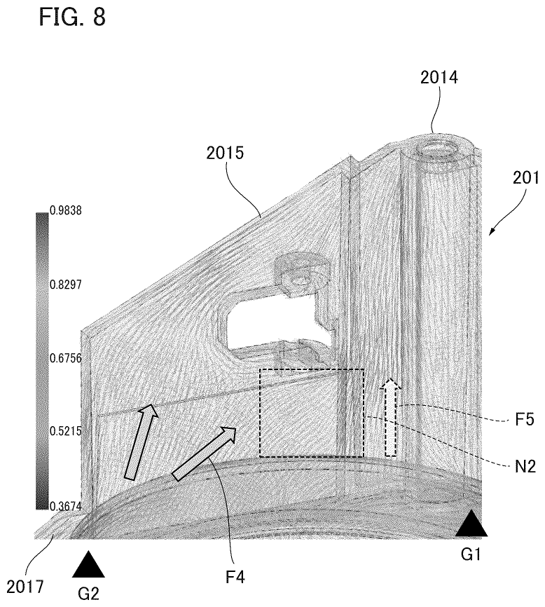

FIG. 7 shows a simulation result of the fiber orientations of the holding frame (eighth group lens barrel 116) according to Present Embodiment. FIG. 8 shows a simulation result of the fiber orientations of the eighth group lens barrel 201 which does not have a shape as the uneven shape 1168 of the holding frame (eighth group lens barrel 116) according to Present Embodiment. The directions of fine lines in FIGS. 7 and 8 indicate the fiber orientations. In addition, blackened triangles in the diagrams indicate approximate positions of the gate G1 and the gate G2.

The arrow F1 and the arrows F2 in FIG. 7 indicate flows of the resin from the gate G2 at the time of molding. In Present Embodiment, due to the uneven shape 1168 provided in the first connection portion 1165, the flows of the resin from the gate G2 are obstructed. For this reason, the resin first flows in the direction of the arrow F1. When the surrounding portions of the arrow F1 is filled with the resin, next, the resin flows in the direction of the arrows F2 such that the uneven shape 1168 is molded. At this time, in the surrounding portions of the guided portion 1164, the resin flows in the direction of the arrow F3 from the gate G1. Focusing on the fiber orientations within the range of the dashed line portion N1, since the direction of the arrows F2 and the direction of the arrow F3 are consistent, it can be said that the directions of the fiber orientations are also substantially aligned. In other words, the fiber orientations within the range of the dashed line portion N1 are aligned by providing the uneven shape 1168 in the first connection portion 1165 of the eighth group lens barrel 116.

The arrows F4 in FIG. 8 indicate flows of the resin from the gate G2 at the time of molding. In addition, the resin flows in the direction of the arrow F5 from the gate G1 in the surrounding portions of the guided portion 2014. Focusing on the fiber orientations within the range of the dashed line portion N2, since the arrows F4 and the arrow F5 are not consistent, the directions of the fiber orientations are not aligned.

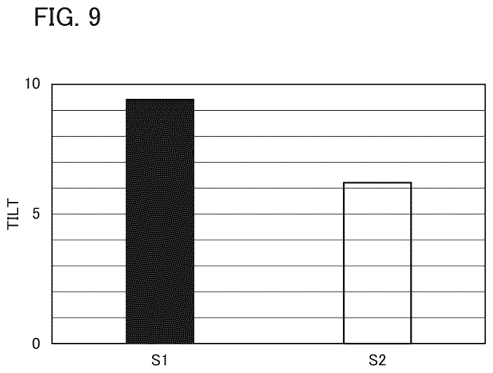

FIG. 9 is a graph showing an effect of restraining change in tilt in the lens unit according to Present Embodiment. The vertical axis in FIG. 9 indicates values of a simulation result of the amount of change in tilt [min]. In FIG. 9, the amount of change in tilt of the eighth group lens barrel 201 caused by change in environmental temperature is indicated by a variation amount S1. Moreover, the amount of change in tilt of the eighth group lens barrel 116 is indicated by a variation amount S2. The difference between the shapes of the eighth group lens barrel 201 and the eighth group lens barrel 116 is that the eighth group lens barrel 201 does not have the uneven shape 1168 provided in the first connection portion 1165 of the eighth group lens barrel 116. Namely, this indicates that the amount of change in tilt caused by change in environmental temperature can be restrained from the variation amount S1 to the variation amount S2 by providing the uneven shape 1168 in the first connection portion 1165 of the eighth group lens barrel 116.

Here, in order to cause flows of the resin from the direction of the arrow F1 to the direction of the arrows F2 in FIG. 7, it is preferable that the uneven shape 1168 overlap the holding portion 1167 when viewed in a direction orthogonal to the optical axis X direction.

In addition, in order to restrain change in tilt caused by change in environmental temperature, there is a need to maintain a high mechanical strength in the surrounding portions of the guided portion 1164 as described above. The fiber orientations of the uneven shape 1168 and the surrounding portions of the guided portion 1164 can also be aligned by providing the continuous small thickness TH2. However, since the mechanical strength will decrease when the continuous small thickness TH2 is provided, it is not preferable in terms of restraining change in tilt caused by change in environmental temperature. The uneven shape 1168 according to Present Embodiment is a shape in which the large thickness TH1 and the thickness TH2 smaller than the thickness TH1 are alternately repeated a plurality of times as described above. In this manner, it is possible to achieve both aligning the fiber orientations and securing the mechanical strength.

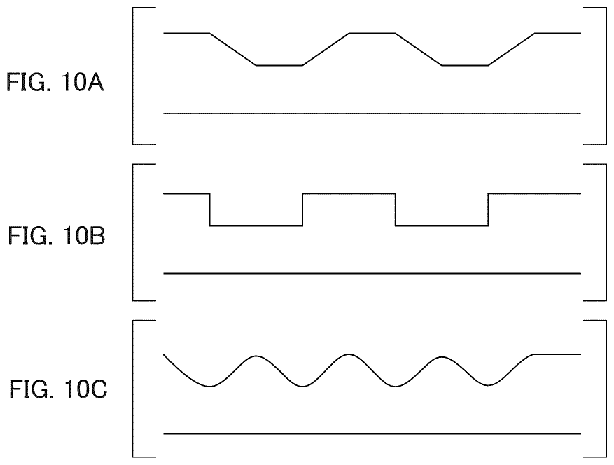

The uneven shape 1168 of Present Embodiment is a shape in which triangular shapes are repeated as shown in FIG. 6B. However, it is not limited thereto, and it may be a shape in which trapezoidal shapes are repeated as shown in FIG. 10A. Alternately, it may be a shape in which rectangular shapes are repeated as shown in FIG. 10B. Alternately, it may be a wave shape as shown in FIG. 10C. In other words, the uneven shape 1168 can be at least any of repetition of triangular shapes, repetition of trapezoidal shapes, repetition of rectangular shapes, and a wave shape.

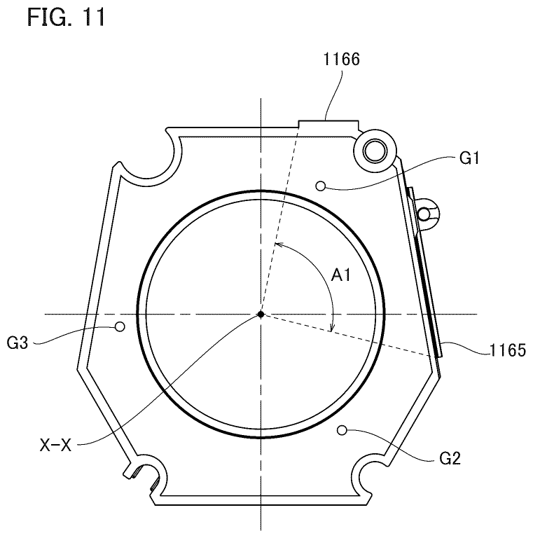

FIG. 11 is a front view of the holding frame (eighth group lens barrel 116) according to Present Embodiment. In FIG. 11, gate positions at the time of molding are indicated by the gate G1, the gate G2, and the gate G3. Here, the gate G1 is provided within a range A1 formed by a dashed line connecting the first connection portion 1165 to the optical axis X and a dashed line connecting the third connection portion 1166 to the optical axis X. In other words, when viewed in a direction along the optical axis X (when viewed in a plane orthogonal to the optical axis X), the gate G1 at the time of molding is provided within the range connecting the optical axis X to the position where the first connection portion 1165 is connected to the holding portion 1167. The fiber orientations around the guided portion 1164 shown in FIG. 7 can be in the direction of the arrow F3 by disposing the gate G1 within the range A1. As a result, the direction of the arrows F2 can be further aligned with the arrow F3.

In Present Embodiment, one uneven shape 1168 in which the large thickness TH1 and the thickness TH2 smaller than the thickness TH1 are alternately repeated a plurality of times in the optical axis X direction is provided in the first connection portion 1165. However, it is not limited thereto, and another uneven shape may be provided at a position different from the uneven shape 1168 (outside the range of the uneven shape 1168).

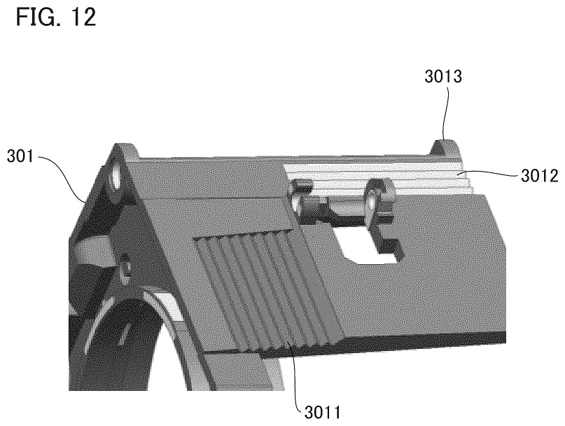

FIG. 12 is a perspective view of the holding frame (eighth group lens barrel 116) according to another embodiment. Specifically, FIG. 12 is a view showing an example in which an uneven shape corresponding to the uneven shape 1168 and another uneven shape different from the uneven shape are provided in a lens barrel 301. Further, for example, as shown in FIG. 12, an uneven shape 3011 corresponding to the uneven shape 1168 may be provided in the lens barrel 301. In addition, and an uneven shape (second shape) 3012 in which the thickness repeatedly increases and decreases in a direction orthogonal to the optical axis X may be provided at a place different from the uneven shape 3011. In other words, the second shape (uneven shape 3012) is formed such that the first thickness and the second thickness smaller than the first thickness are alternately repeated a plurality of times in a direction orthogonal to the optical axis X. The constitutions such as the position and the shape of the uneven shape 3011 are similar to those of the foregoing uneven shape 1168. In addition, the lens barrel 301 corresponds to the eighth group lens barrel 116.

Here, the uneven shape 3012 may be provided at any position as long as it does not overlap the uneven shape 1168. However, as shown in FIG. 12, the directions of the fiber orientations may be controlled by providing the uneven shape 3012 around a guided bar 3013. That is, the second shape (uneven shape 3012) in which the first thickness and the second thickness smaller than the first thickness are alternately repeated a plurality of times in the direction of the first connection portion 1165 from the guided bar 3013 along a side surface on the outer circumferential side of the lens barrel 301 is provided.

Although the uneven shape 3012 differs from the uneven shape 3011 in direction by approximately 90 degrees, but other constitutions such as the mountain portions and the valley portions can be similar to those of the uneven shape 3011 corresponding to the uneven shape 1168, detailed description will be omitted. In addition, similar to the uneven shape 1168 described above, the uneven shape 3012 can be at least any of repetition of triangular shapes, repetition of trapezoidal shapes, repetition of rectangular shapes, and a wave shape.

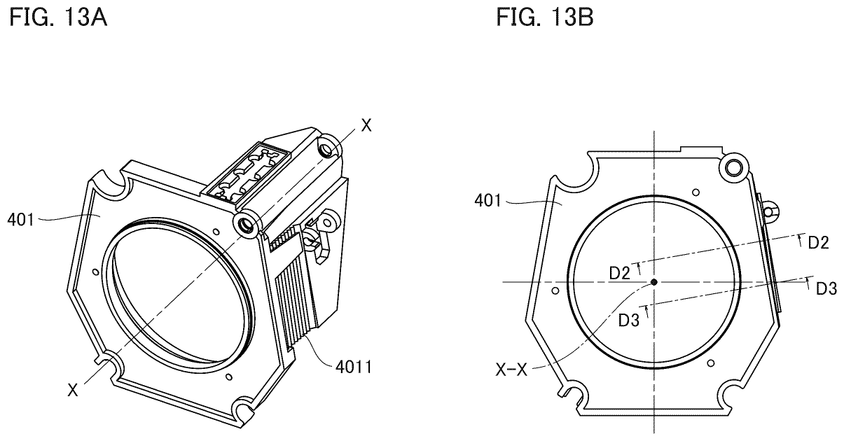

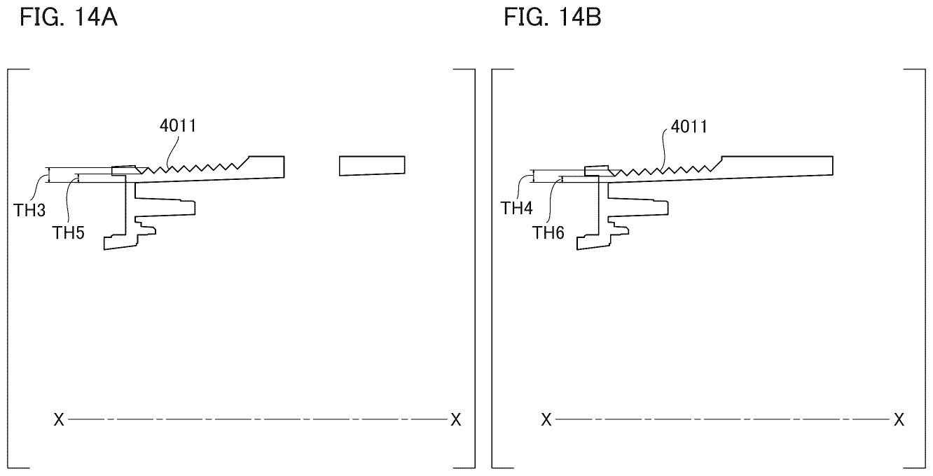

In addition, in Present Embodiment, the large thickness TH1 and the small thickness TH2 of the uneven shape 1168 have a shape in which the thickness does not change in a direction orthogonal to the optical axis X. FIGS. 13 and 14 are a perspective view and a front view of the holding frame (eighth group lens barrel 116) according to another embodiment. FIG. 13A is a perspective view of a lens barrel 401 having a shape of an uneven shape 4011 corresponding to the uneven shape 1168. FIG. 13B is a front view of the lens barrel 401 having a shape of the uneven shape 4011 corresponding to the uneven shape 1168. FIG. 14A is a cross-sectional view showing the cross section of D2-D2 in FIG. 13B. FIG. 14B is a cross-sectional view showing the cross section of D3-D3 in FIG. 13B. The position of the uneven shape 4011 is similar to that of the foregoing uneven shape 1168. In addition, the lens barrel 401 corresponds to the eighth group lens barrel 116.

A thickness TH3 in the uneven shape 4011 in FIG. 14 is larger than a thickness TH4. In addition, a thickness TH5 in the uneven shape 4011 in FIG. 14 is larger than a thickness TH6. Namely, in the example shown in FIGS. 13 and 14, the thickness in the uneven shape becomes thinner (smaller) as the uneven shape 4011 becomes farther from the guided portion, and the thickness in the uneven shape becomes thicker (larger) as it becomes closer to the guided portion. That is, the uneven shape 4011 has a thickness changing in a direction orthogonal to the optical axis X. Accordingly, the thickness can be reduced as it becomes closer from the gate G2, and the resin can flow more effectively in the directions of the arrow F1 and the arrows F2.

In addition, the uneven shape 1168 according to Present Embodiment is a shape in which the mountain portions and the valley portions having the same thickness and the same shape are alternately repeated. However, it is not limited thereto, and for example, as shown in FIG. 6B, the uneven shape 1168 may be formed to have any of the plurality of shapes shown in FIG. 10 from the middle of the shape in which triangular shapes are repeated. That is, the uneven shape 1168 and the uneven shape 3012 may be formed by combining one of the shapes shown in FIG. 6B and FIG. 10 described above with one or a plurality of shapes different from the shape.

Hereinabove, according to Present Embodiment, it is possible to provide a lens unit in which tilt variation of a lens holding frame caused by change in environmental temperature can be simply restrained with a compact constitution without providing another member.

Each of the foregoing Present Embodiments described above is merely a representative example, and various modifications and changes can be made for each of the embodiments when implementing the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014862, filed Feb. 2, 2024, which is hereby incorporated by reference wherein in its entirety.

What is claimed is:

1. A lens unit comprising:
an optical member including a lens;
a resin-molded holding frame holding the optical member;
a guide member guiding movement of the holding frame in a direction along an optical axis of the optical member;
a holding portion holding the optical member;
a guided portion abutting the guide member; and
a first connection portion connecting the holding portion and the guided portion,
wherein the first connection portion has a first shape in which a first thickness and a second thickness smaller than the first thickness are alternately repeated a plurality of times in a direction along the optical axis from a position overlapping the holding portion when viewed in a direction orthogonal to the optical axis.

2. The lens unit according to claim 1,
wherein the first shape has mountain portions having the first thickness and valley portions having the second thickness, and the first shape is formed by alternately connecting the mountain portions and the valley portions.

3. The lens unit according to claim 1,
wherein the first shape has a shape in which the thickness repeatedly increases and decreases a plurality of times in a direction along the optical axis from a position overlapping the holding portion when viewed in a direction orthogonal to the optical axis.

4. The lens unit according to claim 1,
wherein the first shape is formed as a shape in which recesses and projections are continuously formed in a direction along the optical axis or a teeth shape.

5. The lens unit according to claim 1,
wherein the first shape is disposed on an outward side with respect to the optical axis.

6. The lens unit according to claim 1,
wherein the guided portion has a first abutment portion disposed at a distance in a direction along the optical axis and abutting the guide member, a second abutment portion, and a second connection portion connecting the first abutment portion and the second abutment portion.

7. The lens unit according to claim 1,
wherein a gate at the time of molding the holding frame is disposed within a range connecting the optical axis and a position where the first connection portion is connected to the holding portion when viewed in an optical axis direction.

8. The lens unit according to claim 1,
wherein the holding frame has a second shape in which the first thickness and the second thickness are alternately repeated a plurality of times in a direction orthogonal to the optical axis from the guided portion outside a range of the first shape.

9. The lens unit according to claim 1,
wherein the first shape has a thickness changing in a direction orthogonal to the optical axis.

10. The lens unit according to claim 9,
wherein the thickness increases toward the guided portion.

11. The lens unit according to claim 1,
wherein the first shape is at least any of repetition of triangular shapes, repetition of trapezoidal shapes, repetition of rectangular shapes, or a wave shape.

12. The lens unit according to claim 8,
wherein the second shape is at least any of repetition of triangular shapes, repetition of trapezoidal shapes, repetition of rectangular shapes, or a wave shape.

13. An imaging apparatus comprising:
an optical member including a lens;
a resin-molded holding frame holding the optical member;
a guide member guiding movement of the holding frame in a direction along an optical axis of the optical member;
a holding portion holding the optical member;
a guided portion abutting the guide member; and
a first connection portion connecting the holding portion and the guided portion,
wherein the first connection portion has
a lens unit having a first shape in which a first thickness and a second thickness smaller than the first thickness are alternately repeated a plurality of times in a direction along the optical axis from a position overlapping the holding portion when viewed in a direction orthogonal to the optical axis, and
an image sensor imaging a subject through the lens.
